(19) United States
(12) Patent Application Publication
(10) Pub. No.: US 2022/0360436 A1
(43) Pub. Date: Nov. 10, 2022

(54) COMPUTER-READABLE RECORDING MEDIUM STORING GENERATION PROGRAM, GENERATION METHOD, AND INFORMATION PROCESSING APPARATUS

(71) Applicant: FUJITSU LIMITED, Kawasaki-shi (JP)

(72) Inventor: YUTAKA NAKAMURA, Atsugi (JP)

(73) Assignee: FUJITSU LIMITED, Kawasaki-shi (JP)

(21) Appl. No.: 17/591,632

(22) Filed: Feb. 3, 2022

(30) Foreign Application Priority Data
May 7, 2021 (JP) 2021-078927

(51) Int. Cl. H04L 9/08

(52) U.S. Cl. CPC H04L 9/0858

(57) ABSTRACT

A non-transitory computer-readable recording medium stores a generation program for causing a computer to execute processing including: acquiring a converted character string from a character string to be processed in predetermined processing that includes hashing the character string to be processed; generating a figure that corresponds to the character string to be processed by representing an order of characters and a value of a character in the converted character string as an angle and a size in polar coordinates; and outputting the figure.

### CROSS-REFERENCE TO RELATED APPLICATION

This application is based upon and claims the benefit of priority of the prior Japanese Patent Application No. 2021-78927, filed on May 7, 2021, the entire contents of which are incorporated herein by reference.

### FIELD

The embodiment discussed herein is related to a generation program, a generation method, and an information processing apparatus.

### BACKGROUND

In recent years, from the viewpoint of security, a multiple character string such as a hash ID (SHA-256, 64 characters in hexadecimal) has been increasingly used as a key or an ID. For example, in a blockchain, a hash value is used as an identifier (ID).

Furthermore, a technique has been known that is related to conversion from a character string into a figure.

Japanese Laid-open Patent Publication No. 2002-318993 and Japanese Laid-open Patent Publication No. 2011-197873 are disclosed as related art.

### SUMMARY

According to an aspect of the embodiments, a non-transitory computer-readable recording medium stores a generation program for causing a computer to execute processing including: acquiring a converted character string from a character string to be processed in predetermined processing that includes hashing the character string to be processed; generating a figure that corresponds to the character string to be processed by representing an order of characters and a value of a character in the converted character string as an angle and a size in polar coordinates; and outputting the figure.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating an expression of an exemplary multiple character string;

FIG. 2 is a diagram illustrating a block configuration of an information processing apparatus according to an embodiment;

FIG. 3 is a diagram illustrating conversion of a character string into a figure using polar coordinates;

FIGS. 4A to 4C are diagrams illustrating conversion of a character string into a figure using polar coordinates according to the embodiment;

FIGS. 5A to 5C are diagrams illustrating identification of two similar character strings according to the embodiment;

FIGS. 6A to 6D are diagrams illustrating an example of generating a plurality of figures for a character string to be identified according to the embodiment;

FIGS. 7A to 7D are diagrams illustrating an example of generating a figure after the number of elements in the character string is reduced;

FIGS. 8A to 8C are diagrams illustrating an example in which colors are arranged in a figure using a part of a hash value obtained from the character string to be identified as a color code;

FIG. 9 is a diagram illustrating ease of identification in a case where the character string to be identified is displayed;

FIG. 10 is a diagram illustrating a case where the character string to be identified is represented as a bitmap;

FIG. 11 is a diagram illustrating a case where a character string is represented as a figure by converting the character string into the figure using the polar coordinates according to the embodiment;

FIG. 12 is a diagram illustrating a pair including left and right character strings different from each other;

FIG. 13 is a diagram illustrating a display of a character string identification result according to the embodiment;

FIG. 14 is a diagram illustrating an operation flow of figure generation processing according to the embodiment; and

FIG. 15 is a diagram illustrating a hardware configuration of a computer used to implement the information processing apparatus according to the embodiment.

### DESCRIPTION OF EMBODIMENTS

However, when a character string becomes long, it tends to be difficult to identify whether or not the character string is correct. As a result, for example, there is a case where identification takes time or erroneous identification is performed. Therefore, it is desired to provide a technique for facilitating identification whether or not the character string is correct even in a case where a multiple character string is used.

In one aspect, an object of the embodiment is to facilitate identification of a character string.

Hereinafter, several embodiments will be described in detail with reference to the drawings. Note that corresponding elements in a plurality of drawings are denoted with the same reference numeral.

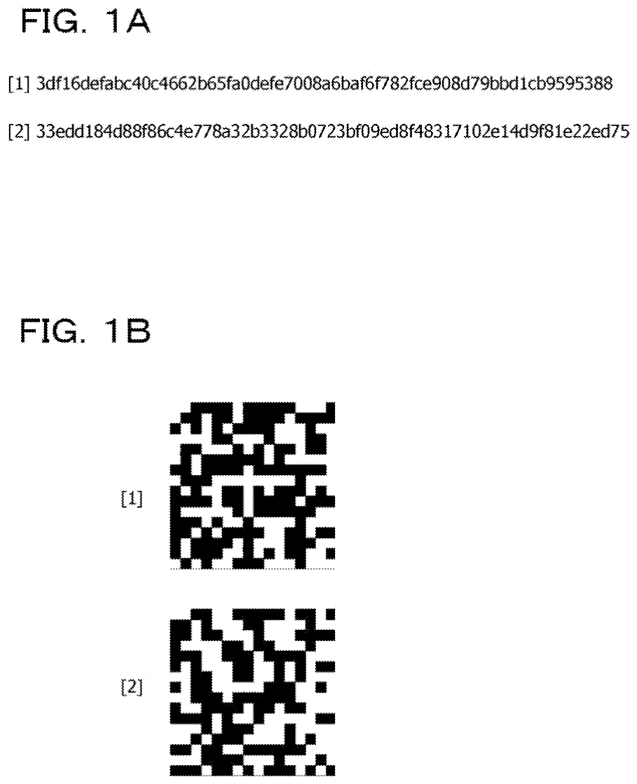

FIGS. 1A and 1B are diagrams illustrating an expression of an exemplary multiple character string. In FIG. 1A, two character strings [1] and [2] are illustrated as multiple character strings. Note that, as an example, the character string may be a hash value. For example, when the character string is long as illustrated in FIG. 1A, it is difficult for a person to remember or identify the character string that is used by the person. Therefore, for example, even in a case where the person is requested to confirm the character string, it may be difficult to determine whether or not the character string is the same as the character string that is usually used by the person. Furthermore, for example, in a case where a long character string is compared with another character string, it may be difficult to determine whether or not the character string matches or is different from the another character string.

As a method for facilitating identification of the character string, for example, it is considered to convert the character string into a binary bit string and display bits as a bitmap expressed in black and white. FIG. 1B illustrates a bitmap display in which bit strings obtained by converting hexadecimal character strings [1] and [2] in FIG. 1A into binary numbers are arranged from the left to the right and from the top to the bottom in order in two colors including white and black. As illustrated in FIG. 1B, even if the character string is displayed as a bitmap, it cannot be said that improvement in ease of the identification is sufficient. Therefore, it is desired to provide a technique further facilitating the identification of a multiple character string.

Note that, the multiple of the multiple character string may be, for example, the number of characters of which a difference is difficult for a human to identify, and in an example, a character string having a predetermined number of characters or more may be regarded as a multiple character string. Furthermore, an application target of the embodiment is not limited to the multiple character string, and may also be applied to a plural character string having several characters. Hereinafter, the embodiment will be described using a character string as a term including the multiple character string and the plural character string. Hereinafter, the identification of the character string according to the embodiment will be further described.

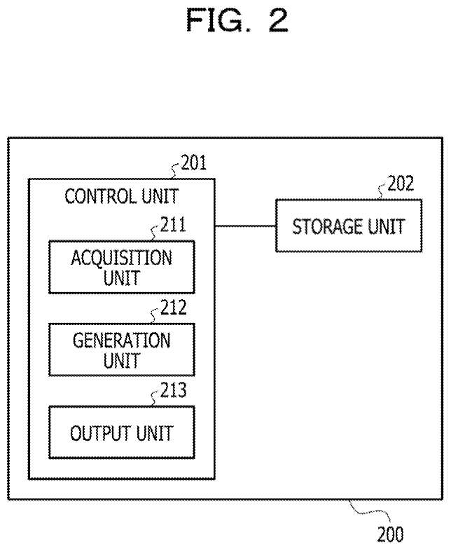

FIG. 2 is a diagram illustrating a block configuration of an information processing apparatus 200 according to the embodiment. The information processing apparatus 200 may be, for example, a computer that has an arithmetic function such as a server computer, a personal computer, a mobile computer, a smartphone, a mobile phone, a tablet terminal, or a wearable terminal. The information processing apparatus 200 includes, for example, a control unit 201 and a storage unit 202. The control unit 201 includes, for example, an acquisition unit 211, a generation unit 212, an output unit 213, or the like and may also include other functional units. The storage unit 202 of the information processing apparatus 200 stores, for example, information such as a character string to be processed, which will be described later. Details of these units will be described later.

Then, in the embodiment, the control unit 201 converts a character string into a graph with polar coordinates so as to convert the character string into a figure.

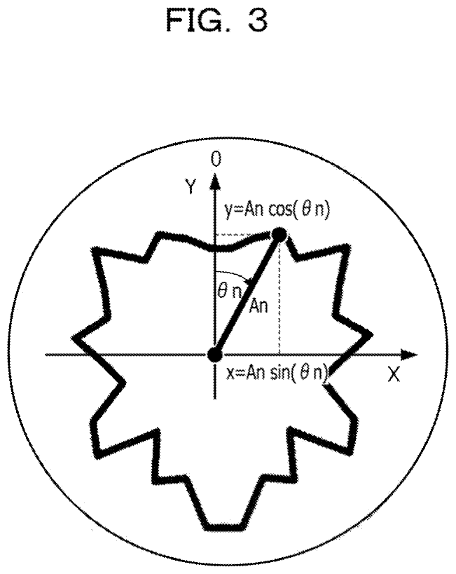

FIG. 3 is a diagram illustrating conversion of a character string into a figure using the polar coordinates. In the example of the polar coordinates in FIG. 3, the horizontal direction is set as the X-axis, and the vertical direction is set as the Y-axis. Furthermore, upward of the Y-axis is set to zero degree, and a clockwise direction is set to a positive angle. Then, in the embodiment, for example, a character included in a target character string is represented by an angle and a value in the polar coordinates. For example, it is assumed that there be a hexadecimal character string represented with N characters. In this case, for example, by dividing 360 degrees of one round by the number of characters N, it is possible to obtain an angle corresponding to one character. For example, in a case where the character string includes 64 characters, by dividing 360 degrees of one round by 64 characters, it is possible to obtain an angle corresponding to one character as 5.625 degrees. Then, for example, it is assumed that a number from an end of target characters included in the character string be n. In this case, an angle θn of the n-th character can be expressed as 5.625×n. Furthermore, a value of the n-th character in the character string is set as An. For example, in a case of a hexadecimal character string, the value An can be represented by a numerical value of zero to 15 corresponding to a hexadecimal value corresponding to the n-th character.

In this case, the x-axis coordinate of the n-th character can be expressed by the following formula 1.

x=An×sin(θn) Expression 1

Furthermore, the y-axis coordinate of the n-th character can be expressed by the following formula 2.

y=An×cos(θn) Expression 2

Then, for example, by connecting each point with a straight line according to a character order in the character string, it is possible to convert the character string into a figure using the polar coordinates. Note that the axes, the positive angle direction, or the like in FIG. 3 are examples, and may also be set to different directions.

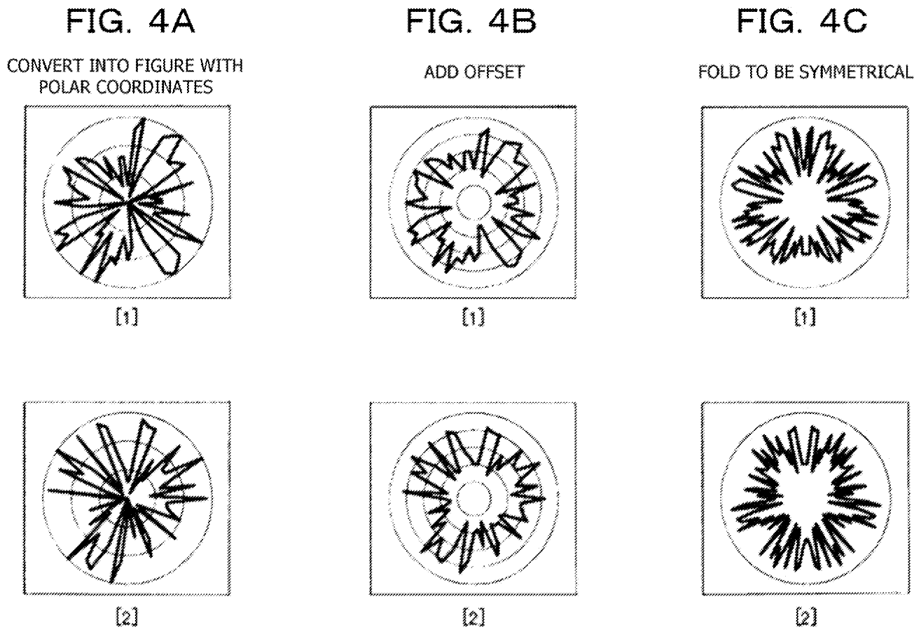

FIGS. 4A to 4C are diagrams illustrating conversion of a character string into a figure using the polar coordinates according to the embodiment. FIG. 4A is an example in which the character strings [1] and [2] in FIGS. 1A and 1B are converted into figures using the polar coordinates. As illustrated in FIG. 4A, through the conversion into the figure using the polar coordinates, recognition is more easily performed than a case where the characters are recognized in FIG. 1A and a case where the bitmap is recognized in FIG. 1B. For example, the figure illustrated in FIG. 4A is easy to remember its shape for a human, and it is possible to easily recognize that figures [1] and [2] in FIG. 4A are different from each other.

Furthermore, the inventor of the embodiment has found that, because the entire figure gives an impression of a needle-like shape when the figure represented in the polar coordinates is close to the center of the polar coordinates, there is a possibility that ease of recognizing other features of the shape is impaired. Therefore, in one embodiment, the control unit 201 may give a predetermined value to a value of a character in a target character string as an offset. Note that, in an example, there is a case where the predetermined value to be added as an offset is referred to as an offset value.

FIG. 4B is a diagram illustrating a character string converted into a figure by adding an offset. For example, in FIG. 4B, five as an offset is add to a value represented by any one of zero to 15 corresponding to a hexadecimal character included in the target character string, and the value of the character is converted into a polar coordinate figure in a range of five to 20. As a result, it is possible to prevent the figure from being closer to the center and to suppress the impression of the needle-like shape. As a result, it is possible to facilitate recognition of the feature of the shape of the figure. In the example illustrated in FIG. 4B, it is possible to more easily recognize that the figures [1] and [2] are different from each other as compared with FIG. 4A.

Furthermore, for example, it has been known that humans tend to strongly recognize a symmetrical figure. For example, in the factor of symmetry that is one of seven elements of the gestalt factors (law of pragnanz), it is described that a symmetrical figure tends to be easily recognized as a set. Furthermore, for example, in the Rorschach test in psychology, symmetrical patterns are used. Therefore, in one embodiment, the control unit 201 may generate a symmetrical figure when the character string is converted into a figure using the polar coordinates.

FIG. 4C is a diagram illustrating a character string converted into a symmetrical figure. For example, in FIG. 4C, by assigning each character of the character string to a section from zero to 180 degrees in the right half of 360 degrees of one round, a figure in a right half of the polar coordinates is generated from the character string. For example, if the character string includes 64 characters, by dividing 180 degrees by 64 characters, it is possible to obtain an angle: 2.8125 corresponding to one character. Then, the control unit 201 generates a symmetrical figure by laterally folding the obtained right-half figure with respect to the Y axis that is the vertical axis as a boundary. As illustrated in FIG. 4C, by expressing the character string as the symmetrical figure, it is possible to easily recognize the feature of the shape of the figure. For example, in the example in FIG. 4C, as compared with FIG. 4A, it is possible to more easily recognize that the figures [1] and [2] are different from each other. Note that, in one example, there is a case where the figure which is generated in one side with respect to the vertical axis of the polar coordinates as a boundary in this way is referred to as a one-side figure.

As described above, because the feature of the character string can be recognized as the figure by converting the character string into the figure represented with the polar coordinates, this facilitates to identify the character string. Furthermore, for example, by adding the offset to the value of the character string or generating the symmetrical figure, the ease of the recognition of the figure can be improved.

However, even if the character string is converted into the figure represented with the polar coordinates in order to improve the ease of the recognition, in a case where an actual difference between character strings is small, it may be difficult to perform identification.

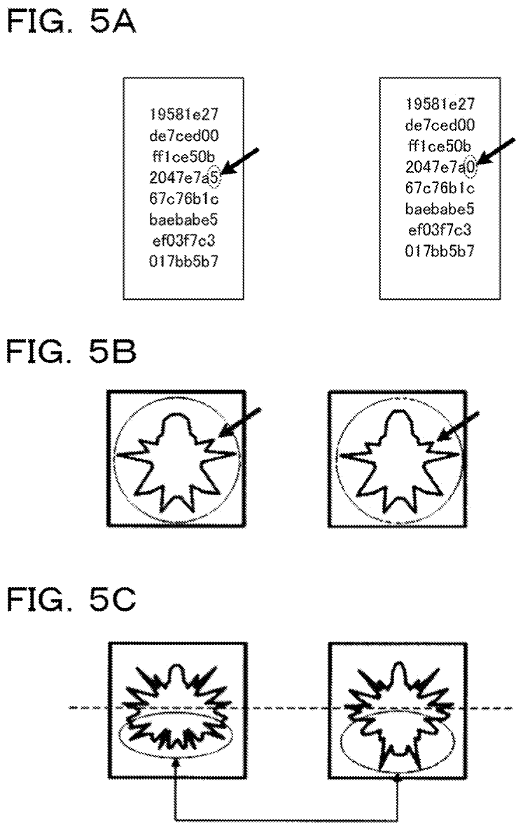

FIGS. 5A to 5C are diagrams illustrating identification of two similar character strings according to the embodiment. FIG. 5A illustrates two character strings. Note that, for example, as indicated by arrows, a difference between the two character strings is only a point that “5” in the left character string is replaced with “0” in the right character string. It is difficult to identify such a difference using the character strings.

Furthermore, FIG. 5B illustrates a figure obtained by converting the character string in FIG. 5A using the polar coordinates. In a case where a difference between the character strings is small, such as a one-character difference in the figures converted using the polar coordinates, only a part of the shapes differs, and most parts are similar to each other. Therefore, there is a case where it is difficult to perform identification. For example, in FIG. 5B, lengths of projections of portions indicated by arrows are slightly different from each other. In this case, it may be difficult to identify the difference. Therefore, in one embodiment, the control unit 201 takes a hash value of a character string to be identified and converts the character string into a figure with the polar coordinates using the hash value. For example, even in a case where two character strings are significantly similar, for example, a case where two character strings have a one-character difference, a probability is very low that hash values respectively obtained by hashing the two character strings are more significantly similar to each other. Therefore, by generating a figure corresponding to the character string to be identified using the hash value of the character string to be identified, even in a case where the character strings to be identified are similar to each other, it is possible to generate figures that can be easily identified.

For example, in FIG. 5C, an example is illustrated in which a character string to be identified is converted into a figure in a range of zero to 90 degrees of the polar coordinates, and in addition, a hash value of the character string to be identified is converted into a figure in a range of 91 to 180 degrees, and a symmetrical figure is generated by vertically folding the figure. As a result, even if the two character strings have a one-character difference that is difficult to be identified as the difference in FIG. 5B, shapes of the lower-half hash value regions are largely different from each other as illustrated in FIG. 5C, and the difference can be easily identified. Therefore, according to the embodiment, it is possible to easily identify even character strings having a small difference.

Note that, in the example in FIGS. 5A to 5C, both of the character string to be identified and the hash value obtained from the character string to be identified are used to generate the figure. However, the embodiment is not limited to this. For example, in another embodiment, when the figure used to identify the character string to be identified is generated, the control unit 201 may also use only a character element included in the hash value of the character string to be identified. Moreover, in addition to the hash value of the character string to be identified, other characters such as the number of characters in the character string to be identified may also be used to generate the figure used to identify the character string to be identified. Hereinafter, another embodiment will be described using a case where the character element included in the hash value of the character string to be identified is used to generate the figure used to identify the character string to be identified as an example.

In the above embodiment, one figure is generated for the character string to be identified. However, the embodiment is not limited to this. For example, when the number of characters in the character string used to generate the figure increases, the number of corners of the figure increases, and there is a case where the figure is complicated. As a result, there is a case where it is difficult for a user to remember or identify the figure. Therefore, for example, in the another embodiment, the control unit 201 may also generate a plurality of figures for the character string to be identified. As a result, it is possible to reduce the number of characters used to express one figure and to simplify the figure and facilitate recognition of the figure.

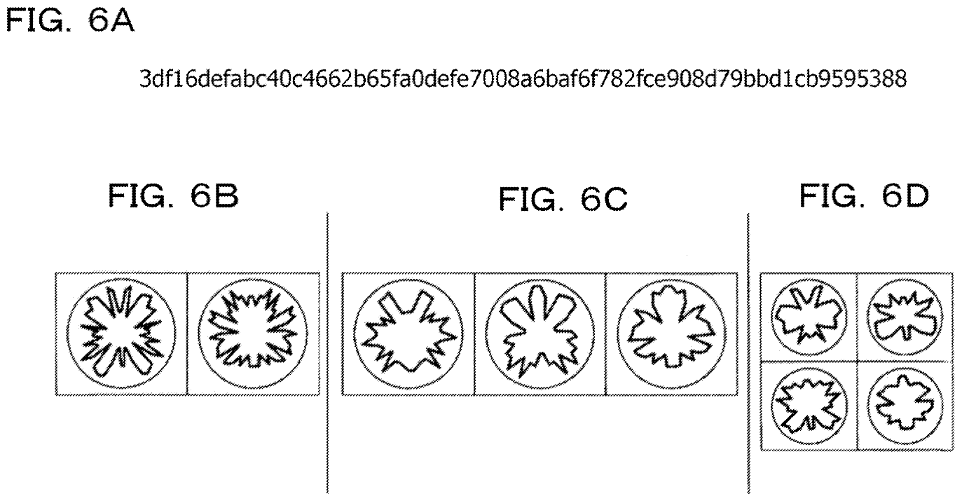

FIGS. 6A to 6D are diagrams illustrating an example of generating a plurality of figures for the character string to be identified according to the embodiment. For example, the control unit 201 may also divide the character string into a plurality of character strings and generate a figure for each of the plurality of character strings.

FIG. 6A illustrates a hash value including 64 characters generated from the character string to be identified. In this case, for example, as illustrated in FIG. 6B, the control unit 201 generates a left-side figure from 32 characters in a first half of the hash value obtained from the character string to be identified and generates a right-side figure from 32 characters in a latter half so as to generate a plurality of figures for the character string to be identified. Therefore, as compared with a case where the feature of the character string is represented as one figure, the shape of the figure can be more simplified, and a user can easily identify the figure. Similarly, FIG. 6C illustrates a figure that is obtained by dividing the hash value obtained from the character string to be identified into three, and FIG. 6D illustrates a figure obtained by dividing the hash value obtained from the character string to be identified into four. Note that, when the character string is divided, the number of characters assigned to each division may also be different for each division, or the character string may also be divided so that the numbers of characters assigned to the respective character strings are equal to each other. Alternatively, a part of the character string may be duplicated when the character string is divided into the plurality of character strings.

Furthermore, for example, in the embodiment in a case where security is not required or the like, the control unit 201 may also reduce the number of character elements according to predetermined processing from the character string used to generate the figure such as the hash value of the character string to be identified and use the character string to generate the figure.

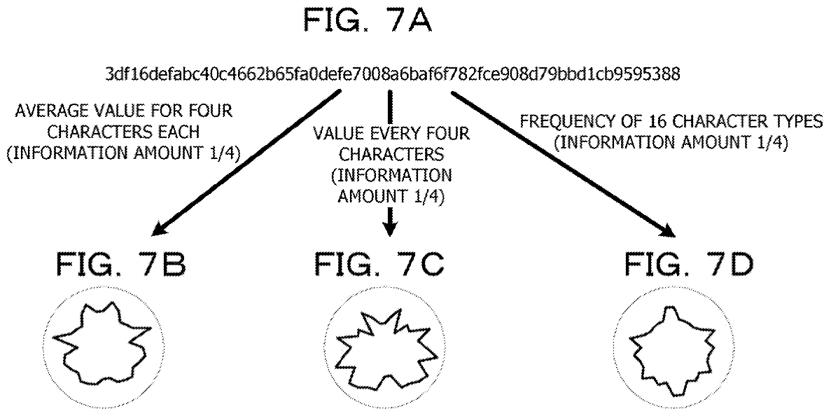

FIGS. 7A to 7D are diagrams illustrating an example of generating a figure after the number of character elements in the character string is reduced. FIG. 7A illustrates a hash value obtained from the character string to be identified. In this case, for example, the control unit 201 may divide the character string of the hash value into four characters each and generate a figure with an average value obtained by averaging hexadecimal values of the four characters (FIG. 7B). Alternatively, in another example, the control unit 201 may also create a figure by using the character string of the hash value every four characters (FIG. 7C). In still another example, for example, the control unit 201 may also acquire a frequency of each of 16 character types of the hexadecimal used as the character string of the hash value and generate a figure using the frequency of the character type as a value (FIG. 7D). Note that an order of the frequencies when the figure is generated may be, for example, an order of the character types of the hexadecimal.

As described above, the control unit 201 can simplify the shape of the figure by generating the figure as reducing the number of character elements in the character string. As a result, it is possible to generate a figure that is easily recognized by the user.

Furthermore, in yet another example, the control unit 201 may convert at least a part of a character string used to generate a figure into a color code, express the character string as a color, and arrange the color in the figure.

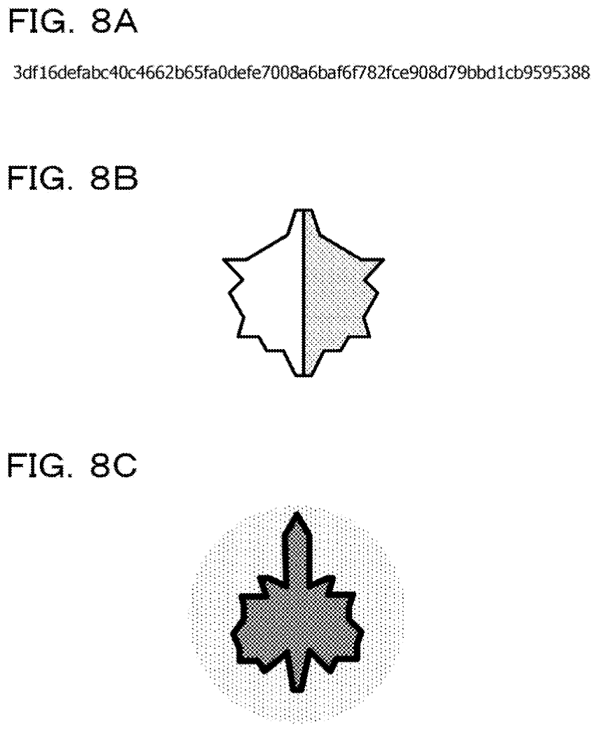

FIGS. 8A to 8C are diagrams illustrating an example in which a part of the hash value obtained from the character string to be identified is used as the color code and is used to color the figure. FIG. 8A illustrates a hash value obtained from the character string to be identified. Then, in FIG. 8B, for example, the control unit 201 determines a color using six characters at the left end of the hash value: 3df16d as an RGB color code and colors the left half of the figure with the color. Furthermore, for example, the control unit 201 determines a color using six characters at the right end of the hash value: 595388 as an RGB color code and colors the right half of the figure with the color. For example, by arranging the color in the figure in this way, the user can recognize the feature of the character string used by the user even using the color, and it is possible to more easily identify the figure. Furthermore, FIG. 8C illustrates an example in which colors are arranged in an inside and outside of a figure. In this way, in the embodiment, the control unit 201 may arrange a color at any position such as the outside of the figure. Furthermore, in this case, the control unit 201 does not need to use the character string, which has been converted into the color code and used as the color, to generate the figure. As a result, the number of corners of the figure can be reduced, and the shape can be simplified.

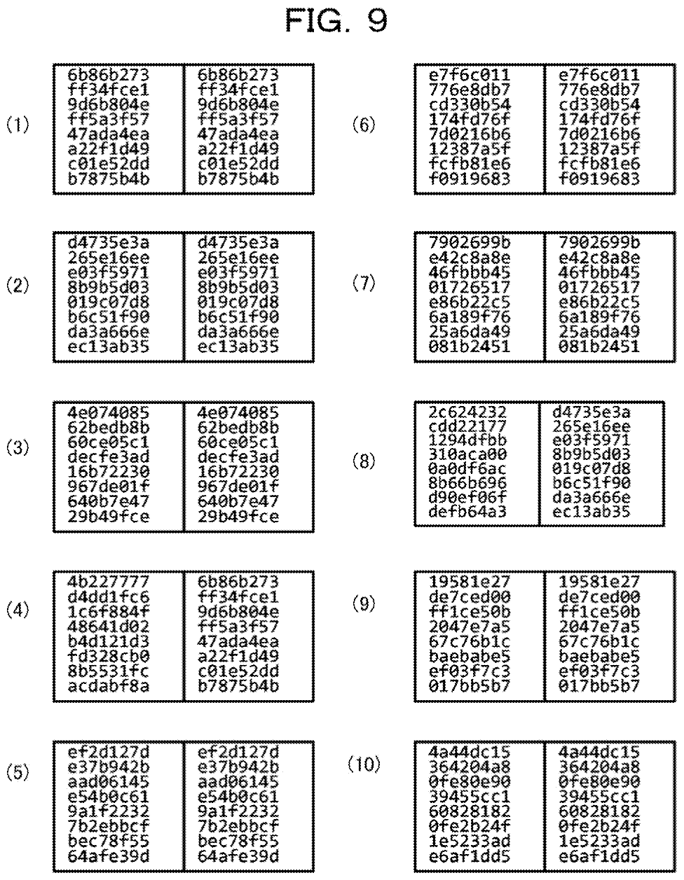

As described above, according to the embodiment, the identification of the character string is facilitated. FIGS. 9 to 11 are diagrams illustrating the identification of the character string.

FIG. 9 is a diagram illustrating ease of identification in a case where the character string to be identified is displayed. In FIG. 9, 10 pairs of character strings (1) to (10) are illustrated. The 10 pairs of character strings include pairs in which a left character string is the same as a right character string and pairs in which a left character string is different from a right character string. However, in a state of the character string, it is difficult to specify a pair in which the left character string is difficult from the right character string from among the 10 pairs of character strings at a glance.

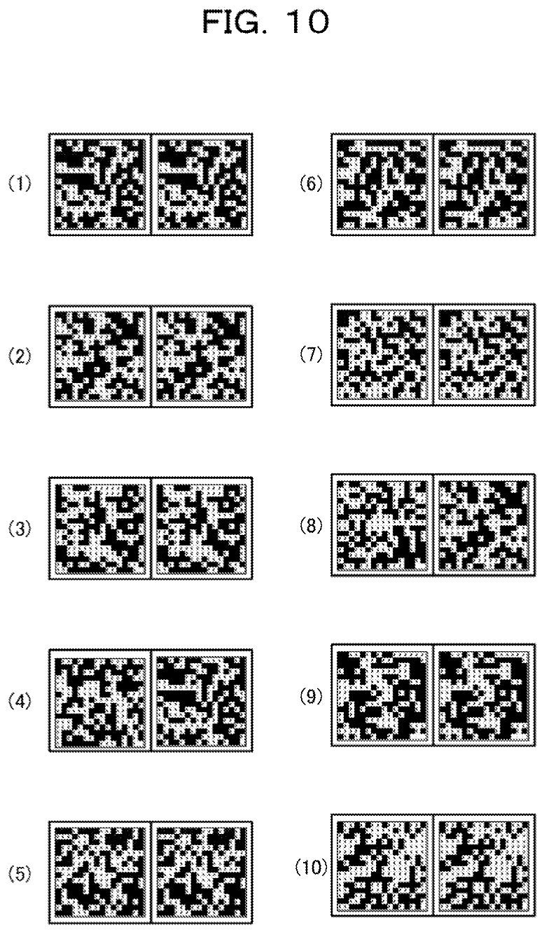

FIG. 10 is a diagram illustrating a case where the character string corresponding to FIG. 9 is represented as a bitmap. As illustrated in FIG. 10, even in a case where the character string is represented as a bitmap, it is difficult to specify a pair in which a left bitmap is difficult from a right bitmap at a glance.

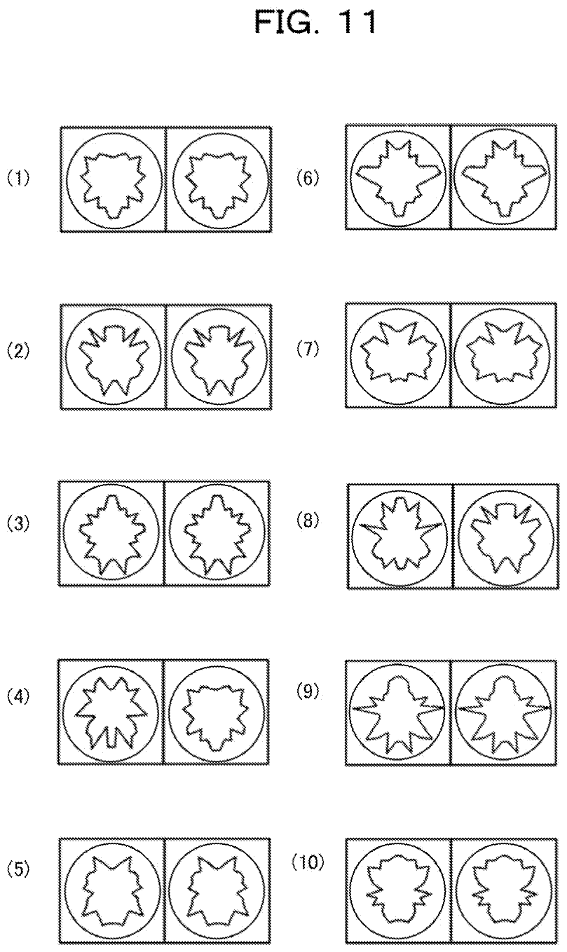

FIG. 11 is a diagram illustrating a case where a character string is represented as a figure by converting the character string into the figure using the polar coordinates according to the embodiment. As illustrated in FIG. 11, by performing conversion into the figure using the polar coordinates, it is possible to easily specify a pair in which a left figure is different from a right figure on the basis of comparison between the figures.

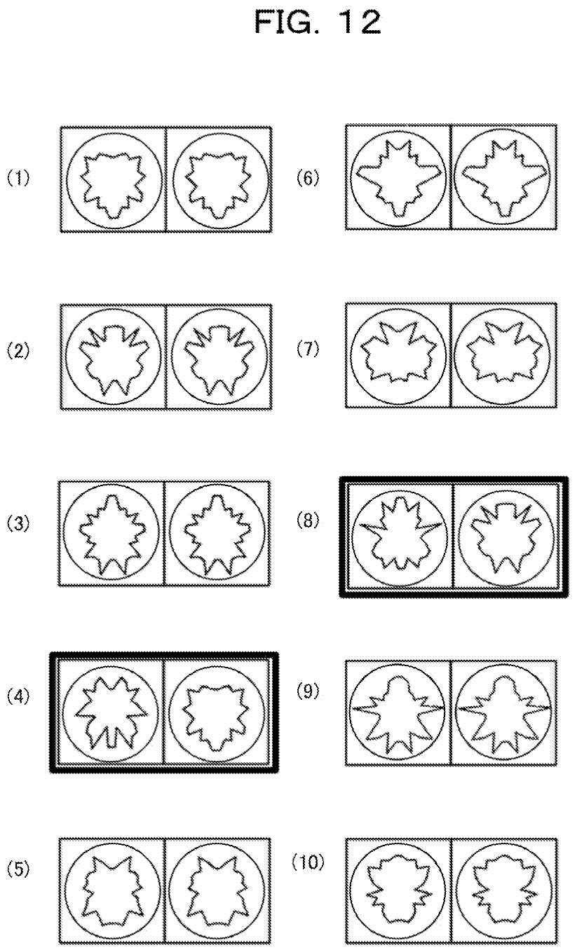

FIG. 12 is a diagram illustrating a pair including left and right character strings different from each other. As illustrated in FIG. 12, the left and right figures are largely different from each other in (4) and (8), it is possible to easily identify that the character strings to be identified used to generate the figures are different.

Furthermore, for example, the embodiment can be used in a case where it is desired to determine whether or not the character strings match and to display the result.

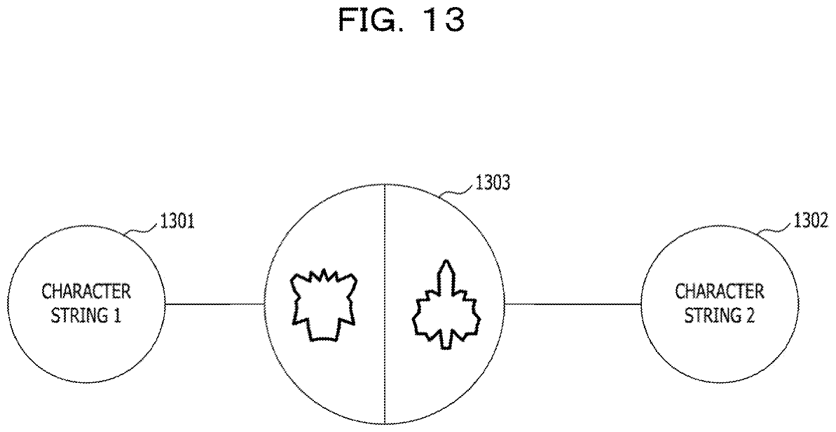

FIG. 13 is a diagram illustrating a display of a character string identification result according to the embodiment. For example, it is assumed that there are two nodes each including a character string as information. In FIG. 13, two nodes including a point 1301 including a character string 1 and a point 1302 including a character string 2 are illustrated. In this case, for example, the control unit 201 displays a section 1303 that connects two points with a line, has a bulge between the two points, and has a boundary orthogonal to the line. Then, for example, the control unit 201 may also display a graphic figure of information regarding the closer point closer, in each of both sides of the boundary of the section 1303. For example, in order to visually check whether or not a falsification or the like is made in information that has two pieces of data that should be the same, such as a data copy source and a data copy destination, the display in FIG. 13 may also be used. The information may be, for example, security information, a hash value of data, or the like. By referring to the display in FIG. 13, a user can easily determine whether or not pieces of information regarding two points match by comparing the figures.

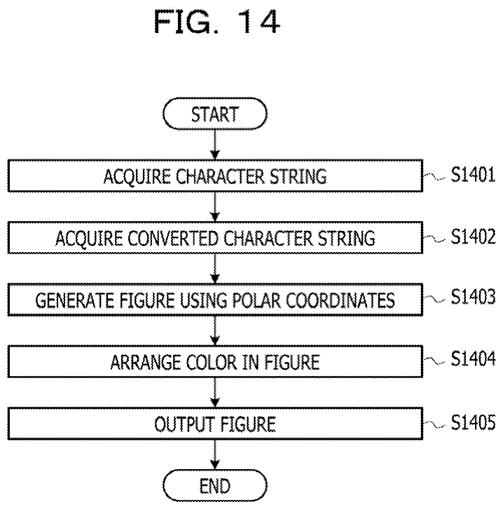

Subsequently, an operation flow for generating a figure corresponding to a character string according to the embodiment described above will be described. FIG. 14 is a diagram illustrating an operation flow of figure generation processing according to the embodiment. For example, upon receiving an instruction to generate a figure for a character string to be processed, the control unit 201 may start the operation flow in FIG. 14.

In step 1401 (hereinafter, step is described as “5”, for example, describe as S1401), the control unit 201 acquires a character string to be processed. For example, the control unit 201 may read the character string to be processed from the storage unit 202.

In S1402, for example, the control unit 201 acquires a character string converted from the character string to be processed through predetermined processing including acquisition of a hash value corresponding to the character string to be processed. For example, the control unit 201 may acquire the hash value corresponding to the character string to be processed as the converted character string by multiplying the character string to be processed by a hash function in the predetermined processing. Furthermore, as described with reference to FIGS. 4A to 4C, the control unit 201 may also further add the offset value to the value represented by the character element of the hash value and acquire the converted character string.

In S1403, for example, the control unit 201 generates a figure corresponding to the character string to be processed by representing an order of characters or a value of the character included in the converted character string corresponding to the character string to be processed as an angle and a size in the polar coordinates. For example, as illustrated in FIG. 3, the control unit 201 may convert the hash value corresponding to the character string to be processed into a figure using the formulas 1 and 2 described above. Note that, for example, the control unit 201 may also contain another character string such as the character string to be processed in the converted character string corresponding to the character string to be processed and use the character string to generate the figure.

Furthermore, when generating a figure, the control unit 201 may generate a one-side figure in one of ranges of a left and a right regions with the vertical axis of the polar coordinates as a boundary and laterally fold the figure along the vertical axis so as to generate a symmetrical figure. As a result, it is possible to generate a figure having a shape that is easily recognized by humans.

Moreover, in another embodiment, the control unit 201 may also generate a plurality of figures from the converted character string when the figure is generated. For example, the control unit 201 may also generate a plurality of figures corresponding to the character string to be processed by dividing the converted character string so as to generate a plurality of character strings and generating a figure for each of the divided character strings.

Furthermore, when generating the figure, the control unit 201 may also generate the figure corresponding to the character string to be processed on the basis of the character string that is obtained as reducing the character elements, as described with reference to FIGS. 7A to 7D, from the converted character string.

In S1404, the control unit 201 arranges a color in the figure. For example, as illustrated in FIGS. 8A to 8C, the control unit 201 may determine a color using at least a part of a character string of the converted character string as a color code and arrange the color in the figure. Note that a position where the color is arranged may be set to any position. For example, in an example, the control unit 201 may paint the color in the figure or a part thereof. In another example, the control unit 201 may also paint the color in a position outside the figure such as a region to be a background of the figure or a part thereof.

In S1405, the control unit 201 outputs the generated figure, and the operation flow ends. For example, the control unit 201 may output the generated figure to a display device connected to the information processing apparatus 200 and display the figure on a display screen of the display device. Note that, in another embodiment, in the processing in S1405, the control unit 201 may also output the generated figure to the storage unit 202 or the like and save the figure or may transmit the generated figure to another device connected to the information processing apparatus 200.

For example, as described with reference to FIG. 14, according to the embodiment, it is possible to generate the figure corresponding to the character string. As a result, the user can easily identify the character string to be identified.

Furthermore, in the embodiment described above, the figure is generated on the basis of the hash value of the character string. Therefore, for example, even the character strings have a small difference, a difference between the generated figures is easily generated, and it is easy to distinguish the figures.

Furthermore, in the embodiment described above, when the figure is generated, the value of the offset is added to the character string of the hash value. As a result, it is possible to prevent the figure from giving a needle-like impression, and facilitate to recognize the shape of the figure.

Furthermore, in the embodiment described above, when the figure is generated, a one-side figure is generated in one of ranges of the left and the right regions with respect to the vertical axis of the polar coordinates, and the one-side figure is laterally folded along the vertical axis so as to generate a symmetrical figure. As a result, it is possible to generate a figure having a shape that is easily recognized by humans.

Moreover, in the embodiment described above, the control unit 201 may also generate the plurality of figures from the character string of the hash value when the figure is generated. Furthermore, when the figure is generated, the control unit 201 may also generate the figure from the character string obtained as reducing the number of character elements on the basis of the character string of the hash value. As a result, the shape of each figure can be simplified. Therefore, the user can easily recognize and identify the figure.

Furthermore, in the embodiment, the color may be determined using a part of the character string of the hash value as a color code, and the color may be arranged in the figure. As a result, the figure can be identified on the basis of the color. Therefore, the user can easily recognize and identify the figure.

Although the embodiment has been described above, the embodiment is not limited to this. For example, the operation flows described above are exemplary, and the embodiment is not limited to this. If possible, the operation flows may also be executed by changing the order of processing or may also additionally include further processing, or a part of processing may also be omitted. For example, in a case where a color is not arranged in a figure, it is not needed to execute the processing in S1404 in FIG. 14.

Note that, in the above embodiment, for example, the control unit 201 operates as the acquisition unit 211 in the processing in S1402. For example, the control unit 201 generates the converted character string for the character string to be processed in the predetermined processing executed in S1402. Note that the converted character string may be, for example, a hash value or may also be a character string obtained by adding the offset value to the value represented by the character element of the hash value. Furthermore, in the processing in S1403 and S1404, the control unit 201 operates, for example, as the generation unit 212. For example, the control unit 201 may generate the figure from the converted character string in the processing in S1403 and S1404 and arrange the color in the figure. In the processing in S1405, the control unit 201 operates, for example, as the output unit 213. For example, the control unit 201 may output the figure generated in the processing in S1405.

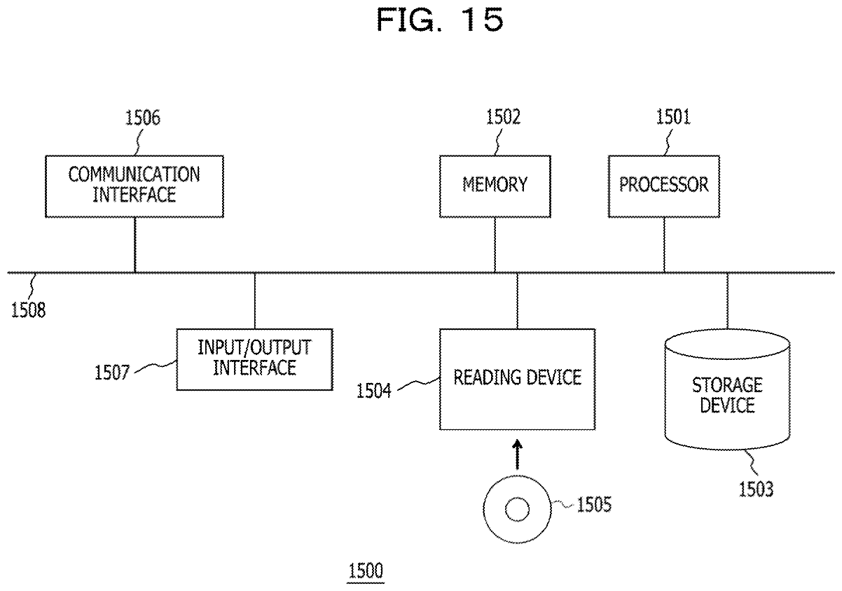

FIG. 15 is a diagram illustrating a hardware configuration of a computer 1500 for implementing the information processing apparatus 200 according to the embodiment. The hardware configuration for implementing the information processing apparatus 200 in FIG. 15 includes, for example, a processor 1501, a memory 1502, a storage device 1503, a reading device 1504, a communication interface 1506, and an input/output interface 1507. Note that the processor 1501, the memory 1502, the storage device 1503, the reading device 1504, the communication interface 1506, and the input/output interface 1507 are connected to each other via a bus 1508, for example.

The processor 1501 may also be, for example, a single processor, a multiprocessor, or a multicore processor. The processor 1501 uses the memory 1502 to execute, for example, a program describing procedures of the operation flows described above, so that some or all of the functions of each unit described above are provided. For example, the processor 1501 of the information processing apparatus 200 reads and executes the program stored in the storage device 1503 so as to operate as the acquisition unit 211, the generation unit 212, and the output unit 213.

The memory 1502 is, for example, a semiconductor memory, and may include a RAM region and a ROM region. The storage device 1503 is, for example, a semiconductor memory such as a hard disk or a flash memory, or an external storage device. Note that the RAM is an abbreviation for random access memory. In addition, the ROM is an abbreviation for read only memory.

The reading device 1504 accesses a removable storage medium 1505 in accordance with an instruction from the processor 1501. The removable storage medium 1505 is implemented by, for example, a semiconductor device, a medium to and from which information is input and output by magnetic action, a medium to and from which information is input and output by optical action, or the like. Note that the semiconductor device is, for example, a universal serial bus (USB) memory. Furthermore, the medium to and from which information is input and output by magnetic action is, for example, a magnetic disk. The medium to and from which information is input and output by optical action is, for example, a CD-ROM, a DVD, or a Blu-ray Disc (Blu-ray is a registered trademark), or the like. The CD is an abbreviation for compact disc. The DVD is an abbreviation for digital versatile disk.

The storage unit 202 includes, for example, the memory 1502, the storage device 1503, and the removable storage medium 1505. For example, the storage device 1503 of the information processing apparatus 200 stores information used for the figure generation processing according to the embodiment, such as the character string to be processed.

The communication interface 1506 communicates with another device according to an instruction from the processor 1501. For example, the information processing apparatus 200 may also receive information regarding a character string from another device via the communication interface 1506 and generate a figure on the basis of the received information regarding the character string so as to provide the figure to the another device.

The input/output interface 1507 is, for example, an interface between an input device and an output device. The input device is, for example, a device such as a keyboard, a mouse, or a touch panel that receives an instruction from a user. The output device is, for example, a display device such as a display or an audio device such as a speaker.

Each program according to the embodiment is provided to the information processing apparatus 200 in the following forms, for example.

(1) Installed on the storage device 1503 in advance.

(2) Provided by the removable storage medium 1505.

(3) Provided from a server such as a program server.

Note that the hardware configuration of the computer 1500 for implementing the information processing apparatus 200 described with reference to FIG. 15 is exemplary, and the embodiment is not limited to this. For example, a part of the configuration described above may also be deleted, or a new configuration may also be added. Furthermore, in another embodiment, for example, a part or all of the functions of the control unit 201 described above may also be implemented as hardware including FPGA, SoC, ASIC, PLD, or the like. Note that the FPGA is an abbreviation for field programmable gate array. The SoC is an abbreviation for system-on-a-chip. The ASIC is an abbreviation for application specific integrated circuit. The PLD is an abbreviation for programmable logic device.

Several embodiments have been described above. However, the embodiment is not limited to the embodiments described above, and it should be understood that the embodiment includes various modifications and alternatives of the embodiments described above. For example, it would be understood that various embodiments may be embodied by modifying components without departing from the spirit and scope of the embodiments. Furthermore, it would be understood that various embodiments may be implemented by appropriately combining a plurality of components disclosed in the embodiments described above. Moreover, a person skilled in the art would understand that various embodiments may be implemented by deleting some components from all the components indicated in the embodiments or by adding some components to the components indicated in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a generation program for causing a computer to execute processing comprising:
acquiring a converted character string from a character string to be processed in predetermined processing that includes hashing the character string to be processed;
generating a figure that corresponds to the character string to be processed by representing an order of characters and a value of a character in the converted character string as an angle and a size in polar coordinates; and
outputting the figure.

2. The non-transitory computer-readable recording medium storing the generation program according to claim 1, wherein the acquiring processing includes adding an offset value to a value represented by a character element of a hash value obtained by hashing the character string to be processed in the predetermined processing and generating the converted character string.

3. The non-transitory computer-readable recording medium storing the generation program according to claim 1, wherein the generating processing includes generating a one-side figure in one side with a vertical axis of the polar coordinates as a boundary on the basis of the converted character string and folding the one-side figure along the vertical axis so as to generate the figure that is symmetrical.

4. The non-transitory computer-readable recording medium storing the generation program according to claim 1, wherein the generating processing includes generating a plurality of character strings by dividing the converted character string and generating a plurality of figures that corresponds to the character string to be processed on the basis of the plurality of character strings.

5. The non-transitory computer-readable recording medium storing the generation program according to claim 1, wherein the generating processing includes generating a figure that corresponds to the character string to be processed on the basis of a character string obtained as reducing character elements from the converted character string.

6. The non-transitory computer-readable recording medium storing the generation program according to claim 1, wherein the generating processing includes determining a color by using at least a part of a character string of the converted character string as a color code and arranging the determined color in the figure.

7. A generation method comprising:
acquiring, by a computer, a converted character string from a character string to be processed in predetermined processing that includes hashing the character string to be processed;
generating a figure that corresponds to the character string to be processed by representing an order of characters and a value of a character in the converted character string as an angle and a size in polar coordinates; and
outputting the figure.

8. An information processing apparatus comprising:
a memory; and
a processor coupled to the memory and configured to:
acquire a converted character string from a character string to be processed in predetermined processing that includes hashing the character string to be processed;
generate a figure that corresponds to the character string to be processed by representing an order of characters and a value of a character in the converted character string as an angle and a size in polar coordinates; and
output the figure.
